(19) United States
(12) Patent Application Publication
(10) Pub. No.: US 2015/0246980 A1
(43) Pub. Date: Sep. 3, 2015

(54) CATALYST SYSTEMS

(71) Applicant: SCG CHEMICALS CO., LTD., Bangkok Metropolis (TH)

(72) Inventor: Dermot O'Hare, Oxford (GB)

(21) Appl. No.: 14/432,014

(22) PCT Filed: Sep. 27, 2013
(86) PCT No.: PCT/TH2013/000051

§ 371 Date: Mar. 27, 2015

(30) Foreign Application Priority Data
Sep. 28, 2012 (GB) GB1217351.4

(51) Int. Cl. C08F 4/80; C08F 4/52; C08F 4/76; C08F 4/02

(52) U.S. Cl. CPC C08F 4/80; C08F 4/02; C08F 4/52; C08F 4/76

(57) ABSTRACT

The present invention relates to a process for preparing a catalyst support comprising a layered double hydroxide (LDH), the process comprising,
a) providing a water-wet layered double hydroxide of formula:

[M^{z+}₁₋ₓM′^{y+}ₓ(OH)₂]^{a+}(Xⁿ⁻)_{a/r}.bH₂O (1)
wherein M and M′ are metal cations, z=1 or 2; y=3 or 4, x is 0.1 to 1, preferably x<1, more preferably x=0.1-0.9, b is 0 to 10, X is an anion, r is 1 to 3, n is the charge on the anion and a is determined by x, y and z, preferably a=z(1−x)+xy−2
b) maintaining the layered double hydroxide water-wet,
c) contacting the water-wet layered double hydroxide with at least one solvent, the solvent being miscible with water and preferably having a solvent polarity (P′) in the range 3.8 to 9; and
d) thermally treating the material to produce a catalyst support,
a process for producing a solid catalyst, a polymerization catalyst as well as the use of an olefin polymerization catalyst in a polymerization process.

### FIELD OF THE INVENTION

The present invention relates to a process for producing a catalyst support comprising a layered double hydroxide, and to polymerisation, preferably olefin polymerisation, catalysts incorporating such layered double hydroxides. The invention also relates to polymerisation processes, preferably olefin polymerisation, using such catalysts.

### BACKGROUND

Layered double hydroxides (LDHs) are a class of compounds which comprise two metal cations and have a layered structure. A review of LDHs is provided in Structure and Bonding; Vol 119, 2005 Layered Double Hydroxides ed. X Duan and D. G. Evans. The hydrotalcites, perhaps the most well-known examples of LDHs, have been studied for many years. LDH's can intercalate anions between the layers of the structure. WO 99/24139 discloses use of LDHs to separate anions including aromatic and aliphatic anions.

LDHs have uses in a range of applications such as catalysis, separation technology, optics, medical science, and nano-composite material engineering.

U.S. Pat. No. 7,094,724 discloses a catalyst solid comprising at least one calcined hydrotalcite. Surface area and pore volume, which may at least partly owe to aggregation of the particles, can still be improved. Further, thermal treatment temperatures, such as for calcination, are somewhat high, for example for the use of silica which is typically calcined at a temperature of 400-800° C.

It is an object of the present invention to provide a supported polymerization catalyst having a support which overcomes the drawbacks of the prior art, especially having higher surface area and higher pore volume and/or low particle density, as well as to provide a process for its preparation, its use in a polymerization process, as well as a process for preparing such a catalyst support.

### SUMMARY

The present invention relates to a process for preparing a catalyst support comprising a layered double hydroxide (LDH), the process comprising,
a) providing a water-wet layered double hydroxide of formula:

[M^{z+}₁₋ₓM′^{y+}ₓ(OH)₂]^{a+}(Xⁿ⁻)_{a/r}.bH₂O (1)
wherein M and M′ are metal cations, z=1 or 2; y=3 or 4, x is 0.1 to 1, preferably x<1, more preferably x=0.1-0.9, b is 0 to 10, X is an anion, r is 1 to 3, n is the charge on the anion and a is determined by x, y and z, preferably a=z(1−x)+xy−2
b) maintaining the layered double hydroxide water-wet,
c) contacting the water-wet layered double hydroxide with at least one solvent, the solvent being miscible with water and preferably having a solvent polarity (P′) in the range 3.8 to 9, and
d) thermally treating the material to produce a catalyst support,
   a process for producing a solid catalyst, a polymerization catalyst as well as the use of an olefin polymerization catalyst in a polymerization process.

### BRIEF DESCRIPTION OF THE DRAWINGS

FIG. 1: X-ray diffractogram of: a) (EBI)ZrCl₂ supported on MAO-modified Mg_{0.75}Al_{0.25}(OH)₂(CO₃)_{0.125}.1.36H₂O.0.17(Acetone) (catalyst-supported LDH/MAO); b) MAO-modified Mg_{0.75}Al_{0.25}(OH)₂(CO₃)_{0.125}.1.36H₂O.0.17(Acetone) (LDH/MAO); c) thermally treated MAO-modified Mg_{0.75}Al_{0.25}(OH)₂(CO₃)_{0.125}.1.36H₂O.0.17(Acetone) (LDH/MAO), and d) Mg_{0.75}Al_{0.25}(OH)₂(CO₃)_{0.125}.1.36H₂O.0.17(Acetone) (AMO-LDH).

FIG. 2: X-ray diffractogram of: a) thermally treated Zn_{0.67}Al_{0.33}(OH)₂(CO₃)_{0.125}.0.51(H₂O).0.07(acetone)_being exposed to air, b) thermally treated Zn_{0.67}Al_{0.33}(OH)₂(CO₃)_{0.125}.0.51(H₂O).0.07(acetone)_LDH, and c) ZnAl—CO3 Zn_{0.67}Al_{0.33}(OH)₂(CO₃)_{0.125}.0.51(H₂O).0.07(acetone)_LDH.

FIG. 3: Infrared spectra of LDHs:
a) Ca_{0.67}Al_{0.33}(OH)₂(NO₃)_{0.125}.0.52(H₂O).0.16(acetone) LDH,
b) Mg_{0.75}Al_{0.25}(OH)₂(NO₃)_{0.25}.0.38(H₂O).0.12(acetone) LDH,
c) Mg_{0.75}Al_{0.25}(OH)₂(Cl)_{0.25}.0.48(H₂O).0.04(acetone) LDH,
d) Mg_{0.75}Al_{0.25}(OH)₂(CO₃)_{0.125}.1.36H₂O.0.17(acetone) LDH,
e) Mg_{0.75}Ga_{0.25}(OH)₂(CO₃)_{0.125}.0.59(H₂O).0.12(acetone) LDH, and
f) Mg_{0.75}Al_{0.25}(OH)₂(SO₄)_{0.125}.0.55(H₂O).0.13(acetone) LDH.

FIG. 4: Infrared spectra of [(EBI)ZrCl₂] supported on LDH/MAO with various AMO-LDHs components:
a) Ca_{0.67}Al_{0.33}(OH)₂(NO₃)_{0.125}.0.52(H₂O).0.16(acetone) LDH,
b) Mg_{0.75}Al_{0.25}(OH)₂(NO₃)_{0.25}.0.38(H₂O).0.12(acetone) LDH,
c) Mg_{0.75}Al_{0.25}(OH)₂(Cl)_{0.25}.0.48(H₂O).0.04(acetone) LDH,
d) Mg_{0.75}Al_{0.25}(OH)₂(CO₃)_{0.125}.1.36H₂O.0.17(acetone) LDH,
e) Mg_{0.75}Ga_{0.25}(OH)₂(CO₃)_{0.125}.0.59(H₂O).0.12(acetone) LDH, and
f) Mg_{0.75}Al_{0.25}(OH)₂(SO₄)_{0.125}.0.55(H₂O).0.13(acetone) LDH.

FIG. 5: SEM image:
a) Mg_{0.75}Ga_{0.25}(OH)₂(CO₃)_{0.125}.0.59(H₂O).0.12(acetone) LDH,
b) thermally treated Mg_{0.75}Ga_{0.25}(OH)₂(CO₃)_{0.125}.0.59(H₂O).0.12(acetone) LDH,
c) Mg_{0.75}Ga_{0.25}(OH)₂(CO₃)_{0.125}.0.59(H₂O).0.12(acetone) LDH/MAO support,
d) [(EBI)ZrCl₂] supported Mg_{0.75}Ga_{0.25}(OH)₂(CO₃)_{0.125}.0.59(H₂O).0.12(acetone) LDH/MAO catalyst.

FIG. 6: Molecular weight distribution of polyethylene using [(EBI)ZrCl₂] supported on MAO-modified Ca_{0.67}Al_{0.33}(OH)₂(NO₃)_{0.125}.0.52(H₂O).0.16(acetone) (catalyst-LDH/MAO) under the condition of 10 mg of catalyst, 1 bar of ethylene, 2000 equiv MAO: 1 equiv (EBI)ZrCl₂, 15 min at temperature of: a) 60° C. and b) 80° C.

FIG. 7: SEM image of polyethylene using (EBI)ZrCl₂ supported MAO-modified Ca_{0.67}Al_{0.33}(OH)₂(NO₃)_{0.125}.0.52(H₂O).0.16(acetone) LDH/MAO catalyst under the condition of 10 mg of catalyst, 1 bar of ethylene, 2000 Al: 1 Zr, 60° C., 15 min, hexane (25 ml) with different cocatalyst: a) MAO and b) TIBA.

FIG. 8: Thermogravimetric analysis curves of polyethylene obtained from (EBI)ZrCl₂ supported LDH/MAO catalyst with a variety of LDH components (RT to 600° C. at 10° C./min heating rate):
(a) Ca_{0.67}Al_{0.33}(OH)₂(NO₃)_{0.125}.0.52(H₂O).0.16(acetone) LDH);
(b) Mg_{0.75}Al_{0.25}(OH)₂(NO₃)_{0.25}.0.38(H₂O).0.12(acetone) LDH;
(c) Mg_{0.75}Al_{0.25}(OH)₂(Cl)_{0.25}.0.48(H₂O).0.04(acetone) LDH;
(d) Mg_{0.75}Al_{0.25}(OH)₂(SO₄)_{0.125}.0.55(H₂O).0.13(acetone) LDH;
(e) Mg_{0.75}Al_{0.25}(OH)₂(CO₃)_{0.125}.1.36H₂O.0.17(Acetone) LDH;
(f) Mg_{0.75}Al_{0.25}(OH)₂(B₄O₅(OH)₄)_{0.125}.0.53(H₂O).0.21 (acetone) LDH;
(g) Mg_{0.75}Ga_{0.25}(OH)₂(CO₃)_{0.125}.0.59(H₂O).0.12(acetone) LDH, under the condition of 10 mg of catalyst, 1 bar of ethylene, 2000 Al(MAO): 1 equiv (EBI)ZrCl₂, 60° C., 15 min, 25 ml of hexane.

FIG. 9: Thermogravimetric analysis (TGA) curve of polyethylene (a) and (b) and poly(ethylene-co-hexene) (c) and (c) using (EBI)ZrCl₂ supported on MAO-modified Mg_{0.75}Al_{0.25}(OH)₂(SO₄)_{0.125}.0.55(H₂O).0.13(acetone) LDH/MAO catalyst with different 1-hexene content: (a) 0 M; (b) 0.05 M; (c) 0.10 M; and (d) 0.20 M, under the condition of 10 mg of catalyst, 1 bar of ethylene, 2000 MAO:1 equiv (EBI)ZrCl₂, 60° C., 15 min, 25 ml of hexane.

### DETAILED DESCRIPTION

The present invention accordingly provides, in a first aspect, a process for preparing a catalyst support comprising a layered double hydroxide (LDH), the process comprising,
a. providing a water-wet layered double hydroxide of formula:

[M^{z+}₁₋ₓM′^{y+}ₓ(OH)₂]^{a+}(Xⁿ⁻)_{a/r}.bH₂O (1)
wherein M and M′ are metal cations, z=1 or 2; y=3 or 4, x is 0.1 to 1, preferably x<1, more preferably x=0.1-0.9, b is 0 to 10, X is an anion, r is 1 to 3, n is the charge on the anion and a is determined by x, y and z, preferably a=z(1−x)+xy−2;
b. maintaining the layered double hydroxide water-wet,
c. contacting the water-wet layered double hydroxide with at least one solvent, the solvent being miscible with water and preferably having a solvent polarity (P′) in the range 3.8 to 9, thereby producing a material comprising a layered double hydroxide, and
d. thermally treating the material obtained in step c) to produce a catalyst support.

This process is greatly advantageous because, despite being such a simple process, it, surprisingly, results in highly porous and highly dispersed catalyst support, preferably having a low particle density, which function as highly effective catalyst supports. For instance, for the conventionally synthesized Zn₂Al-borate LDH, its specific surface area (N₂) and total pore volume are only 13 m²/g and 0.08 cc/g, respectively.

However, the inventors have discovered that LDH modified according to the invention (even before thermal treatment) has a specific surface area and total pore volume increased to 301 m²/g and 2.15 cc/g, respectively. In addition, the modified LDH has a very uniform particle size of about 5 μm. This method of the invention can be applied to all LDHs. In addition this method is simple and can be easily scaled up for commercial production.

Further, in a preferred embodiment, utilizing thermal treatment temperatures of about 150° C., this results in catalyst supports to be prepared using an easy, energy saving and cost effective process.

Advantageously, if the materials are subsequently thermally treated (at about 150° C.) and then chemically modified with e.g. alkyl aluminium reagents they are excellent supports for metal-organic catalyst precursors. In particular, they can be used to immobilize (or support) metallocenes and other catalyst precursors for olefin polymerization.

In order to obtain a polymerization catalyst, it is essential to
a. synthesize a modified layered double hydroxide as described above,
b. thermally treat, preferably at 100-200° C., the thus prepared modified LDH, so as to retain a crystalline LDH structure,
c. modify the thermally treated LDH with an activator, preferably an alkyl aluminium activator, most preferably methyl-aluminoxane (MAO), and
d. support a complex, for example metallocene or other complex, that can polymerize or co-polymerize an olefin.

The catalyst support prepared has unique features regarding the powder dispersion (low particle density), surface area/pore volume, thermal characteristics and the ability to make effective dispersions of the support in a hydrocarbon solvent in order to prepare immobilized catalyst precursors.

In preparing the catalyst support, surface bound water is replaced by the solvent thus making the particles of the support hydrophobic. Low temperature thermal treatment then activates the surface by solvent desorption (which can be seen in thermogravimetric analysis) and leaves a very unique and reactive surface for catalyst immobilization.

The solvent washing process and the thermal activation of the LDH also modifies the surface chemistry to give beneficial effects on the catalysis, such as the ability to immobilize a significantly larger amount of metal catalyst.

For preparing the inventive catalyst support, the thermal treatment, is of major importance. Thermal activation is preferably carried out above 100° C. and most preferably between 125-200° C. After thermal activation, the support still remains a crystalline LDH, which can be shown by XRD.

Surprisingly, the inventors have discovered that supports produced according to the invention can be used to support catalysts that are very active for polymerisation including olefin polymerisation, for example ethylene polymerization and also for ethylene/hexene copolymerization, in the presence of alkyl aluminium activators and preferably scavengers and/or co-catalysts. However, the catalyst support prepared according to the present invention can be used for all types of supported catalytic polymerization. Preferably, the catalyst prepared according to the present invention can be utilized in slurry polymerization, for example using hexane as solvent. Industrial slurry polymerizations for olefins are well known in the art.

Even more surprisingly and advantageously, the support appears to act not just as an inert support but as an active component of the catalyst system; both the identity of the metal cation (i.e., e.g., the M²⁺ and M′³⁺ ions) and the intercalated anion affects the overall catalyst performance in olefin polymerisation, enabling properties to be tuned according to the process required.

The LDH morphology in the support also influences the polymer morphology, including e.g. enabling the production of spherical polymer particles.

The inventive catalyst support can affect polymerization activity, polymer morphology, and polymer weight distribution for any given metal catalyst.

The water-wet LDH should not dry before contacting the solvent and is preferably a water slurry of LDH particles.

Solvent polarity (P′) is defined based on experimental solubility data reported by Snyder and Kirkland (Snyder, L. R.; Kirkland, J. J. In Introduction to modern liquid chromatography, 2nd ed.; John Wiley and Sons: New York, 1979; pp 248-250,) and as described in the table in the Examples section, below.

Preferably, in step a., as stated above, a substance comprising a water-wet layered double hydroxide of formula (1) may be provided.

In a most preferred embodiment, the at least one solvent is not water.

M may be a single metal cation or a mixture of different metal cations for example Mg, Zn, Fe for a MgFeZn/Al LDH. Preferred M are Mg, Zn, Fe, Ca or a mixture of two or more of these.

M′ may be a single metal cation or a mixture of different metal cations, for example Al, Ga, Fe. The preferred M′ is Al. The preferred value of y is 3.

Preferably, z is 2 and M is Ca or Mg or Zn or Fe.

Preferably, M is Zn, Mg or Ca, and M′ is Al.

Preferred values of x are 0.2 to 0.5, preferably 0.22 to 0.4, more preferably 0.23 to 0.35.

Overall, as is clear for a skilled artisan, the LDH according to formula (1) must be neutral, so that the value of a is determined by the number of positive charges and the charge of the anion.

The anion in the LDH may be any appropriate anion, organic or inorganic for example halide (e.g. chloride), inorganic oxyanions (e.g. XₘOₙ(OH)ₚ^{q-}; m=1-5; n=2-10; p=0-4, q=1-5; X=B, C, N, S, P: e.g. borate, nitrate, phosphate, sulphate), and/or anionic surfactants (such as sodium dodecyl sulfate, fatty acid salts or sodium stearate).

Preferably, the particles of the LDH have a size in the range 1 nm to 200 microns, more preferably 2 nm to 30 microns and most preferably 2 nm-20 microns.

Generally, any suitable organic solvent, preferably anhydrous, may be used but the preferred solvents are selected from one or more of acetone, acetonitrile, dimethylformamide, dimethylsulfoxide, dioxane, ethanol, methanol, n-propanol, iso-propanol, 2-propanol or tetrahydrofuran. The preferred solvent is acetone. Other preferred solvents are alkanols e.g. methanol or ethanol.

The role of the organic solvent is to strip the surface bound water from the water wet LDH particles. The dryer the solvent, the more water can be removed and thus the LDH dispersion be improved. More preferably, the organic solvent contains less than 2 weight percent water.

Preferably, the layered double hydroxide, modified according to the inventive process and used in the support, has a specific surface area (N₂) in the range 155 m²/g to 850 m²/g, preferably 170 m²/g to 700 m²/g, more preferably 250 m²/g to 650 m²/g. Preferably, the modified layered double hydroxide has a BET pore volume (N₂) greater than 0.1 cm³/g. Preferably, the modified layered double hydroxide has a BET pore volume (N₂) in the range 0.1 cm³/g to 4 cm³/g, preferably 0.5 cm³/g to 3.5 cm³/g, more preferably 1 to 3 cm³/g.

Preferably, the process results in a material (e.g. before the thermal treatment step) having a de-aggregation ratio greater than 2, preferably greater than 2.5, more preferably in the range 2.5 to 200. The de-aggregation ratio is the ratio of the BET surface area of the inventive material compared to a comparative.

Such a comparison is based on an identical LDH synthesis in which the water wet LDH is just dried and not been treated with the water miscible solvent. The deaggregation ratio is closely related to the % decrease in particle densities.

Preferably, the process results in a catalyst support having an apparent density of less than 0.8 g/cm³, preferably less than 0.5 g/cm³, more preferably less than 0.4 g/cm³. Apparent density may be determined by the following procedure. The LDH as a free-flowing powder was filled into a 2 ml disposable pipette tip, and the solid was packed as tight as possible by tapping manually for 2 minutes. The weight of the pipette tip was measured before and after the packing to determine the mass of the LDH. Then the apparent density of LDH was calculated using the following equation:

Apparent density=LDH weight (g)/LDH volume (2 ml)

The catalyst support has preferably a loose bulk density of 0.1-0.25 g/ml. The loose bulk density was determined by the following procedure: the freely flowing powder was poured into a graduated cylinder (10 ml) using the solid addition funnel. The cylinder containing the powder was tapped once and the volume measured. The loose bulk density was determined using equation (1).

Loose bulk density=m/V₀ (1)

Wherein m is the mass of the powder in the graduated cylinder, V₀ is the powder volume in the cylinder after one tap.

Preferably, the thermal treatment step comprises a heating profile in the temperature range 20° C. to 1000° C., preferably for a predetermined time at a predetermined pressure. Preferred temperature ranges are 20° C. to 250° C., more preferably 20° C. to 150° C.; 150° C. to 400° C.; and 400° C. to 1000° C., more preferably 500° C. to 600° C. Even more preferred, the temperature range is from 125-200° C.

A preferred predetermined pressure is in the range 1×10⁻¹ to 1×10⁻³ mbar, preferably around 1×10⁻² mbar.

Preferably, a predetermined time is in the range of 1-10 hours, more preferably 6 hours for thermal treatment.

The layered double hydroxide (LDH) as used in the catalyst support could be called aqueous miscible organic-LDHs (AMO-LDHs). The AMO-LDHs used for the catalyst support of the present invention have characteristics and properties as in more detail described in the copending GB1217348 and in the PCT application based on this GB application, both incorporated herein by reference, and see also below.

In a second aspect, there is provided a process for producing an activated catalyst support (solid catalyst), the process comprising providing a catalyst support as in the first aspect, and contacting the support with an activator.

Preferably, in the second aspect the process further comprises contacting the support, before, simultaneously with or after contacting the support with the activator, with at least one metal-organic compound.

Thus, in a third aspect, the present invention provides a polymerisation catalyst comprising, a) a catalyst support prepared according to the invention and b) at least one metal-organic compound.

Preferably, the catalyst further comprises an activator, more preferably an alkyl aluminium activator. Preferred activators include trialkyl aluminium (e.g. triisobutyl aluminium, triethyl aluminium) and/or methylaluminoxane (MAO).

Preferably, the metal-organic compound comprises a transition metal compound, more preferably a titanium, zirconium, hafnium, iron, nickel and/or cobalt compound.

In a preferred embodiment, the catalyst is suitable for ethene and alpha olefin homo-polymerisation or co-polymerisation for example, ethene/hexene co-polymerisation.

Thus, in a fourth aspect, there is provided an olefin polymerisation process using the catalyst of the third aspect.

Further preferred embodiments can be taken from the subclaims.

It is also possible that a prepolymerized catalyst comprising the catalyst support according to claim 1 and, polymerized onto the catalyst solid, linear C₂-C₁₀-1-alkenes, wherein the catalyst solid and the alkenes polymerized onto it are present in a mass ratio of from 1:0.1 to 1:200, may be used.

Further advantages and features of the subject-matter of the present invention can be taken from the following detailed description taking in conjunction with the drawing, in which:

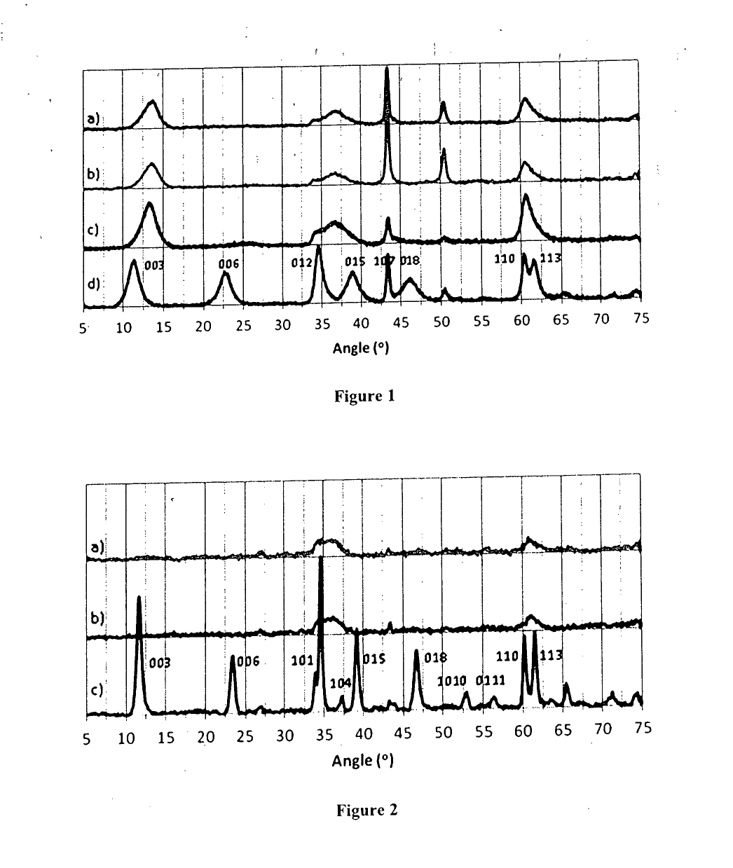

FIG. 1: X-ray diffractogram of: a) (EBI)ZrCl₂ supported on MAO-modified Mg_{0.75}Al_{0.25}(OH)₂(CO₃)_{0.125}.1.36H₂O.0.17(Acetone) (catalyst-supported LDH/MAO); b) MAO-modified Mg_{0.75}Al_{0.25}(OH)₂(CO₃)_{0.125}.1.36H₂O.0.17(Acetone) (LDH/MAO); c) thermally treated MAO-modified Mg_{0.75}Al_{0.25}(OH)₂(CO₃)_{0.125}.1.36H₂O.0.17(Acetone)______(LDH/MAO), and d) Mg_{0.75}Al_{0.25}(OH)₂(CO₃)_{0.125}.1.36H₂O.0.17(Acetone) (AMO-LDH).

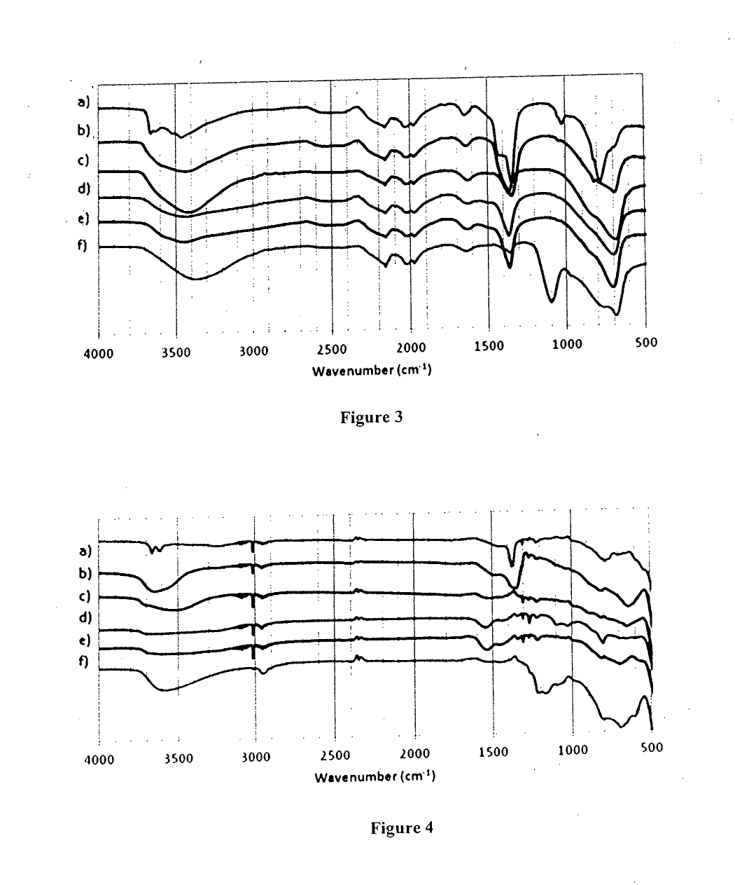

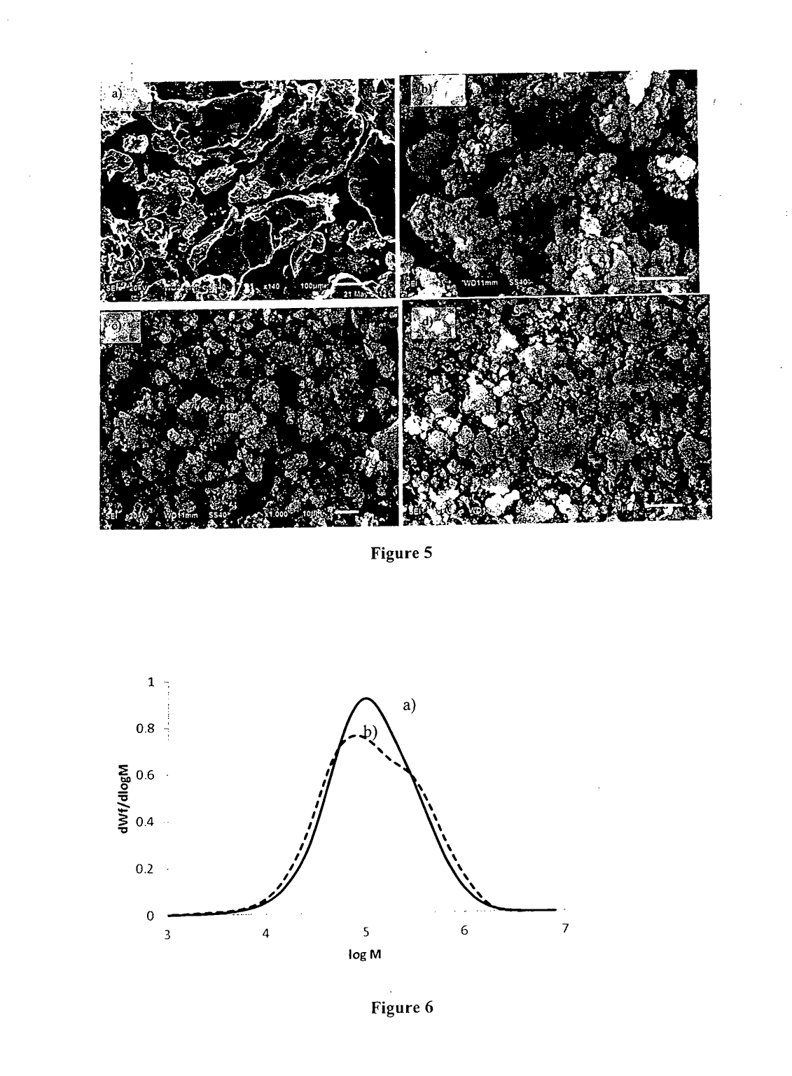

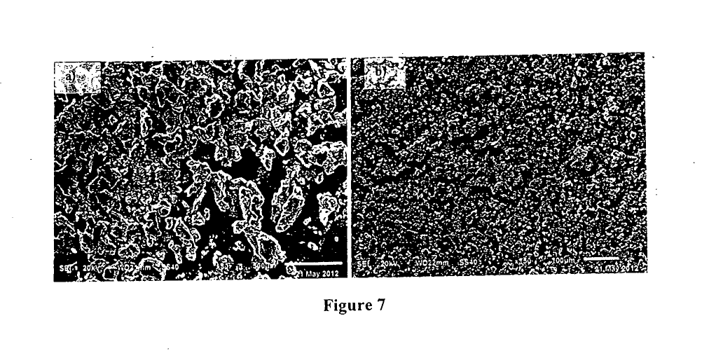

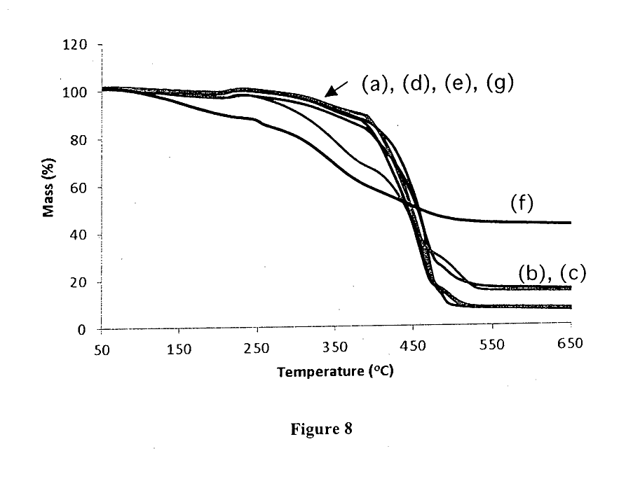

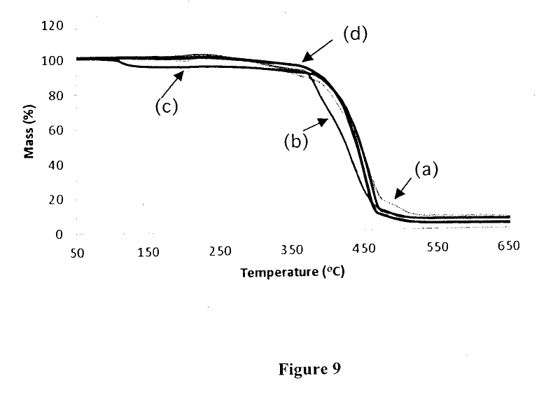

FIG. 2: X-ray diffractogram of: a) thermally treated Zn_{0.67}Al_{0.33}(OH)₂(CO₃)_{0.125}.0.51(H₂O).0.07(acetone)_being exposed to air, b) thermally treated Zn_{0.67}Al_{0.33}(OH)₂(CO₃)_{0.125}.0.51(H₂O).0.07(acetone)_LDH, and c) ZnAl—CO3 Zn_{0.67}Al_{0.33}(OH)₂(CO₃)_{0.125}.0.51(H₂O).0.07(acetone)_LDH.

FIG. 3: Infrared spectra of LDHs:
a) Ca_{0.67}Al_{0.33}(OH)₂(NO₃)_{0.125}.0.52(H₂O).0.16(acetone) LDH,
b) Mg_{0.75}Al_{0.25}(OH)₂(NO₃)_{0.25}.0.38(H₂O).0.12(acetone) LDH,
c) Mg_{0.75}Al_{0.25}(OH)₂(Cl)_{0.25}.0.48(H₂O).0.04(acetone) LDH,
d) Mg_{0.75}Al_{0.25}(OH)₂(CO₃)_{0.125}.1.36H₂O.0.17(acetone) LDH,
e) Mg_{0.75}Ga_{0.25}(OH)₂(CO₃)_{0.125}.0.59(H₂O).0.12(acetone) LDH, and
f) Mg_{0.75}Al_{0.25}(OH)₂(SO₄)_{0.125}.0.55(H₂O).0.13(acetone) LDH.

FIG. 4: Infrared spectra of [(EBI)ZrCl₂] supported on LDH/MAO with various AMO-LDHs components:
a) Ca_{0.67}Al_{0.33}(OH)₂(NO₃)_{0.125}.0.52(H₂O).0.16(acetone) LDH,
b) Mg_{0.75}Al_{0.25}(OH)₂(NO₃)_{0.25}.0.38(H₂O).0.12(acetone) LDH,
c) Mg_{0.75}Al_{0.25}(OH)₂(Cl)_{0.25}.0.48(H₂O).0.04(acetone) LDH,
d) Mg_{0.75}Al_{0.25}(OH)₂(CO₃)_{0.125}.1.36H₂O.0.17(acetone) LDH,
e) Mg_{0.75}Ga_{0.25}(OH)₂(CO₃)_{0.125}.0.59(H₂O).0.12(acetone) LDH, and
f) Mg_{0.75}Al_{0.25}(OH)₂(SO₄)_{0.125}.0.55(H₂O).0.13(acetone) LDH.

FIG. 5: SEM image:
a) Mg_{0.75}Ga_{0.25}(OH)₂(CO₃)_{0.125}.0.59(H₂O).0.12(acetone) LDH,
b) thermally treated Mg_{0.75}Ga_{0.25}(OH)₂(CO₃)_{0.125}.0.59(H₂O).0.12(acetone) LDH,
c) Mg_{0.75}Ga_{0.25}(OH)₂(CO₃)_{0.125}.0.59(H₂O).0.12(acetone) LDH/MAO support,
d) [(EBI)ZrCl₂] supported Mg_{0.75}Ga_{0.25}(OH)₂(CO₃)_{0.125}.0.59(H₂O).0.12(acetone) LDH/MAO catalyst.

FIG. 6: Molecular weight distribution of polyethylene using [(EBI)ZrCl₂] supported on MAO-modified Ca_{0.67}Al_{0.33}(OH)₂(NO₃)_{0.125}.0.52(H₂O).0.16(acetone) (catalyst-LDH/MAO) under the condition of 10 mg of catalyst, 1 bar of ethylene, 2000 equiv MAO: 1 equiv (EBI)ZrCl₂, 15 min at temperature of: a) 60° C. and b) 80° C.

FIG. 7: SEM image of polyethylene using (EBI)ZrCl₂ supported MAO-modified Ca_{0.67}Al_{0.33}(OH)₂(NO₃)_{0.125}.0.52(H₂O).0.16(acetone) LDH/MAO catalyst under the condition of 10 mg of catalyst, 1 bar of ethylene, 2000 Al: 1 Zr, 60° C., 15 min, hexane (25 ml) with different cocatalyst: a) MAO and b) TIBA.

FIG. 8: Thermogravimetric analysis curves of polyethylene obtained from (EBI)ZrCl₂ supported LDH/MAO catalyst with a variety of LDH components (RT to 600° C. at 10° C./min heating rate):
(a) Ca_{0.67}Al_{0.33}(OH)₂(NO₃)_{0.125}.0.52(H₂O).0.16(acetone) LDH);
(b) Mg_{0.75}Al_{0.25}(OH)₂(NO₃)_{0.25}.0.38(H₂O).0.12(acetone) LDH;
(c) Mg_{0.75}Al_{0.25}(OH)₂(Cl)_{0.25}.0.48(H₂O).0.04(acetone) LDH;
(d) Mg_{0.75}Al_{0.25}(OH)₂(SO₄)_{0.125}.0.55(H₂O).0.13(acetone) LDH;
(e) Mg_{0.75}Al_{0.25}(OH)₂(CO₃)_{0.125}.1.36H₂O.0.17(Acetone) LDH;
(f) Mg_{0.75}Al_{0.25}(OH)₂(B₄O₅(OH)₄)_{0.125}.0.53(H₂O).0.21 (acetone) LDH;
(g) Mg_{0.75}Ga_{0.25}(OH)₂(CO₃)_{0.125}.0.59(H₂O).0.12(acetone) LDH, under the condition of 10 mg of catalyst, 1 bar of ethylene, 2000 Al(MAO): 1 equiv (EBI)ZrCl₂, 60° C., 15 min, 25 ml of hexane.

FIG. 9: Thermogravimetric analysis (TGA) curve of polyethylene (a) and (b) and poly(ethylene-co-hexene) (c) and (c) using (EBI)ZrCl₂ supported on MAO-modified Mg_{0.75}Al_{0.25}(OH)₂(SO₄)_{0.125}.0.55(H₂O).0.13(acetone) LDH/MAO catalyst with different 1-hexene content: (a) 0 M; (b) 0.05 M; (c) 0.10 M; and (d) 0.20 M, under the condition of 10 mg of catalyst, 1 bar of ethylene, 2000 MAO:1 equiv (EBI)ZrCl₂, 60° C., 15 min, 25 ml of hexane

The invention is further illustrated by the following Examples.

### EXAMPLES

### 1. Synthesis of LDHs

For a number of sample LDHs the results for surface area, pore volume and deaggregation factor are given in Table 1 below. In column 1 defining the LDH, the last digits after the anion are the pH of the synthesis solution. For example, in line 1 of Table 1, Mg₃Al—CO₃-10 means that the synthesis solution had a pH=10.

The BET surface area (N₂) of a number of samples of LDH is shown in Table 1 together with the de-aggregation factor of the products of inventive process. The apparent density of the samples is shown in Table 1a.

TABLE 1
The Surface Properties of AMO-LDHs and C-LDHs

| | Surface Area (m²/g) | | | Pore Volume (cc/g) | | |
|---|---|---|---|---|---|---|
| | AMO- | | | AMO- | | |
| | LDH- | C- | ³Deaggregation | LDH- | C- | % |
| LDH¹ | A¹ | LDH² | Factor | A¹ | LDH² | Change |
| Mg₃Al—CO₃-10 | 277 | 43 | 6.4 | 0.63 | 0.11 | 472 |
| Mg₂Al—CO₃-10 | 199 | 148 | 1.3 | 1 | 0.9 | 11 |
| Mg₃Al—CO₃-12 | 148 | 41 | 3.6 | 0.405 | 0.13 | 222 |
| Mg₃Al_{0.5}Fe_{0.5}—NO₃-10 | 128 | 91 | 1.4 | 1.1 | 0.68 | 62 |
| Zn₂Al-Borate-8.3 | 301 | 13 | 23 | 2.15 | 0.0816 | 2534 |
| Mg₃Al-Borate-9 | 263 | 1 | 263 | 0.516 | 0.00035 | 147329 |
| Mg₃Al—SO₄-10 | 101 | 14 | 7.2 | 0.305 | 0.012 | 2442 |
| Mg₃Al—NO₃-10 | 169 | 1.5 | 112 | 0.639 | 0.0066 | 9581 |
| Mg₃Al—Cl-10 | 64 | 1 | 64 | 0.319 | 0.0031 | 10190 |
| Zn₃Al—NO₃-8.3 | 61 | 1 | 61 | 0.37 | 0.016 | 2212 |
| Mg₃Al—CO₃-12 | 157 | 43 | 3.65 | 0.94 | 0.11 | 755 |

| LDH¹ | Formula of AMO-LDH-A | Formula of C-LDH |
|---|---|---|
| Mg₃Al—CO₃-10 | Mg_{0.75}Al_{0.25}(OH)₂(CO₃)_{0.125}• | Mg_{0.75}Al_{0.25}(OH)₂(CO₃)_{0.125}• |
| | 1.36H₂O•0.17(Acetone) | 1.67H₂O |
| Mg₂Al—CO₃-10 | Mg_{0.67}Al_{0.33}(OH)₂(CO₃)_{0.125}• | Mg_{0.67}Al_{0.33}(OH)₂(CO₃)_{0.125}• |
| | 0.52(H₂O)•0.16(acetone) | 0.92(H₂O) |
| Mg₃Al—CO₃-12 | Mg_{0.75}Al_{0.25}(OH)₂(CO₃)_{0.125}• | Mg_{0.75}Al_{0.25}(OH)₂(CO₃)_{0.125}• |
| | 1.76H₂O•0.45(Acetone) | 2.83H₂O |
| Mg₃Al_{0.5}Fe_{0.5}—NO₃-10 | Mg_{0.75}Al_{0.125}Fe_{0.125}(OH)₂(CO₃)_{0.125}• | Mg_{0.75}Al_{0.125}Fe_{0.125}(OH)₂(CO₃)_{0.125}• |
| | 0.56(H₂O)•0.07(acetone) | 0.74(H₂O) |
| Zn₂Al-Borate-8.3 | Zn_{0.67}Al_{0.33}(OH)₂(B₄O₅(OH)₄)_{0.125}• | Zn_{0.67}Al_{0.33}(OH)₂(B₄O₅(OH)₄)_{0.125}• |
| | 0.35(H₂O)•0.11(acetone) | 0.66(H₂O) |
| Mg₃Al-Borate-9 | Mg_{0.75}Al_{0.25}(OH)₂(B₄O₅(OH)₄)_{0.125}• | Mg_{0.75}Al_{0.25}(OH)₂(B₄O₅(OH)₄)_{0.125}• |
| | 0.53(H₂O)•0.21(acetone) | 0.59(H₂O) |
| Mg₃Al—SO₄-10 | Mg_{0.75}Al_{0.25}(OH)₂(SO₄)_{0.125}• | Mg_{0.75}Al_{0.25}(OH)₂(SO₄)_{0.125}• |
| | 0.55(H₂O)•0.13(acetone) | 0.06(H₂O) |
| Mg₃Al—NO₃-10 | Mg_{0.75}Al_{0.25}(OH)₂(NO₃)_{0.25}• | Mg_{0.75}Al_{0.25}(OH)₂(NO₃)_{0.25}• |
| | 0.38(H₂O)•0.12(acetone) | 0.57(H₂O) |
| Mg₃Al—Cl-10 | Mg_{0.75}Al_{0.25}(OH)₂(Cl)_{0.25}• | Mg_{0.75}Al_{0.25}(OH)₂(Cl)_{0.25}• |
| | 0.48(H₂O)•0.04(acetone) | 0.61(H₂O) |
| Zn₃Al—NO₃-8.3 | Zn_{0.75}Al_{0.25}(OH)₂(NO₃)_{0.25}• | Zn_{0.75}Al_{0.25}(OH)₂(NO₃)_{0.25}• |
| | 0.32(H₂O)•0.1(acetone) | 0.61(H₂O) |
| Mg₃Al—CO₃-12 | Mg_{0.75}Al_{0.25}(OH)₂(CO₃)_{0.125}• | Mg_{0.75}Al_{0.25}(OH)₂(CO₃)_{0.125}• |
| | 0.44(H₂O)•0.11(methanol) | 1.67(H₂O) |

¹AMO-LDH-S (AMO=aqueous modified organic; S=solvent) is an LDH of formula

[M^{z+}₁₋ₓM′^{y+}ₓ(OH)₂]^{a+}(Xⁿ⁻)_{a/r}.bH₂O (1)

wherein M and M′ are metal cations, z=1 or 2; y=3 or 4, 0<x<1, b=0-10, c=0-10, preferably 0<c<10, X is an anion, n is the charge of the anion, r is 1 to 3 and a=z(1−x)+xy−2. AMO-solvent (A=Acetone, M=Methanol)

²C-LDH is an LDH of formula

[M^{z+}₁₋ₓM′^{y+}ₓ(OH)₂]^{a+}(Xⁿ⁻)_{a/r}.bH₂O (2)

wherein M and M′ are metal cations, z=1 or 2; y=3 or 4, 0<x<1, b=0-10, X is an anion, n is the charge on the anion, r is 1 to 3 and a=z(1−x)+xy−2.

³Deaggregation Factor is defined as the ratio of the BET surface area of acetone washed sample to the water washed sample.

TABLE 1a

| | Apparent | | | | |
|---|---|---|---|---|---|
| | density³ (g/ml) | | Density | | |
| | C- | AMO- | Decrease | | |
| LDHs | LDH² | LDH-A¹ | % | Formula of AMO-LDH-A | Formula of C-LDH |
| Mg₃Al—NO₃-10 | 0.91 | 0.12 | 86.8 | Mg_{0.75}Al_{0.25}(OH)₂(NO₃)_{0.25}• | Mg_{0.75}Al_{0.25}(OH)₂(NO₃)_{0.25}• |
| | | | | 0.38(H₂O)•0.12(acetone) | 0.57(H₂O) |
| Mg₃Al—SO₄-10 | 0.99 | 0.13 | 86.8 | Mg_{0.75}Al_{0.25}(OH)₂(SO₄)_{0.125}• | Mg_{0.75}Al_{0.25}(OH)₂(SO₄)_{0.125}• |
| | | | | 0.55(H₂O)•0.13(acetone) | 0.6(H₂O) |
| Mg₃Al—Cl-10 | 1.03 | 0.24 | 76.7 | Mg_{0.75}Al_{0.25}(OH)₂(Cl)_{0.25}• | Mg_{0.75}Al_{0.25}(OH)₂(Cl)_{0.25}• |
| | | | | 0.48(H₂O)•0.04(acetone) | 0.61(H₂O) |
| Zn₃Al—NO₃-8.3 | 1.24 | 0.31 | 75.0 | Zn_{0.75}Al_{0.25}(OH)₂(NO₃)_{0.25}• | Zn_{0.75}Al_{0.25}(OH)₂(NO₃)_{0.25}• |
| | | | | 0.32(H₂O)•0.1(acetone) | 0.61(H₂O) |
| Mg₃Al-Borate-9 | 1.01 | 0.14 | 86.1 | Mg_{0.75}Al_{0.25}(OH)₂(B₄O₅(OH)₄)_{0.125}• | Mg_{0.75}Al_{0.25}(OH)₂(B₄O₅(OH)₄)_{0.125}• |
| | | | | 0.53(H₂O)•0.21(acetone) | 0.59(H₂O) |
| Zn₂Al-Borate-8.3 | 0.62 | 0.10 | 83.9 | Zn_{0.67}Al_{0.33}(OH)₂(B₄O₅(OH)₄)_{0.125}• | Zn_{0.67}Al_{0.33}(OH)₂(B₄O₅(OH)₄)_{0.125}• |
| | | | | 0.35(H₂O)•0.11(acetone) | 0.66(H₂O) |
| Mg₃Al—CO₃-10 | 0.9 | 0.10 | 90.0 | Mg_{0.75}Al_{0.25}(OH)₂(CO₃)_{0.125}• | Mg_{0.75}Al_{0.25}(OH)₂(CO₃)_{0.125}• |
| | | | | 1.36H₂O•0.17(Acetone) | 1.67H₂O |

¹AMO-LDH-S is an LDH of formula

[M^{z+}₁₋ₓM′^{y+}ₓ(OH)₂]^{a+}(Xⁿ⁻)_{a/r}.bH₂O (1)

wherein M and M′ are metal cations, z=1 or 2; y=3 or 4, 0<x<1, b=0-10, c=0-10, preferably 0<c<10, X is an anion,n is the charge of the anion, r is 1 to 3 and a=z(1−x)+xy−2. AMO-solvent (A=Acetone, M=Methanol)

²C-LDH is an LDH of formula

[M^{z+}₁₋ₓM′^{y+}ₓ(OH)₂]^{a+}(Xⁿ⁻)_{a/r}.bH₂O (2)

wherein M and M′ are metal cations, z=1 or 2; y=3 or 4, 0<x<1, b=0-10, X is an anion, n is the charge of the anion, r is 1 to 3 and a=z(1−x)+xy−2.

³Apparent Density is the weight per unit volume of a LDH powder (after tapping manually for 2 min), this may be different to the weight per unit volume of individual LDH particles.

Method:

Apparent density may be determined by the following procedure. The LDH as a free-flowing powder was filled into a 2 ml disposable pipette tip, and the solid was packed as tight as possible by tapping manually for 2 min. The weight of the pipette tip was measured before and after the packing to determine the mass of the LDH. Then the apparent density of LDH was calculated using the following equation:

Apparent density=LDH weight (g)/LDH volume (2 ml)

In this regard, it has to be noted that the LDHs were prepared as described below, but for the results in Tables 1 and 1a without the thermal treatment step.

### 2 Synthesis of Supported Catalyst

### 2.1 Synthesis of Layered Double Hydroxide (AMO-LDH)

A mixture of M²⁺ and M′³⁺ salt with M²⁺:M′³⁺ molar ratio of 3.0 was dissolved in deionized water, in which the concentration of M²⁺ was 0.75 molL⁻¹. An aqueous solution of an anion source was prepared with Xⁿ⁻/M′³⁺ molar ratio of 2.0, of which the pH was set at 10 by NaOH aqueous solution. The M²⁺/M′³⁺ solution was added dropwise into an anion solution at room temperature under a nitrogen flow whilst maintaining the constant pH. After addition, the resulting slurry was vigorously stirred at room temperature overnight. The obtained LDHs were first filtered and washed with H₂O until pH=7. The still water-wet LDH slurry was then redispersed in acetone. After stirring for about 1-2 h, the sample was filtered and washed with acetone: [M²⁺₁₋ₓM′³⁺ₓ(OH)₂]^{a+}(Xⁿ⁻)_{a/r}.bH₂O.c(acetone) (AMO-LDH).

TABLE 2
Synthesized Layered Double Hydroxides (LDHs)

| M²⁺ | M′³⁺ | Anion | AMO- | |
|---|---|---|---|---|
| source | source | Source | LDH | Chemical formula |
| Ca(NO₃)₂ | Al(NO₃)₃ | NaNO₃ | Ca₂Al—NO₃-10 | Ca_{0.67}Al_{0.33}(OH)₂(NO₃)_{0.125}•0.52(H₂O)•0.16(acetone) |
| Mg(NO₃)₂ | Al(NO₃)₃ | NaNO₃ | Mg₃Al—NO₃-10 | Mg_{0.75}Al_{0.25}(OH)₂(NO₃)_{0.25}•0.38(H₂O)•0.12(acetone) |
| MgCl₂ | AlCl₃ | NaCl | Mg₃Al—Cl-10 | Mg_{0.75}Al_{0.25}(OH)₂(Cl)_{0.25}•0.48(H₂O)•0.04(acetone) |
| Mg(NO₃)₂ | Al(NO₃)₃ | Na₂SO₄ | Mg₃Al—SO₄-10 | Mg_{0.75}Al_{0.25}(OH)₂(SO₄)_{0.125}•0.55(H₂O)•0.13(acetone) |
| Mg(NO₃)₂ | Al(NO₃)₃ | Na₂CO₃ | Mg₃Al—CO₃-10 | Mg_{0.75}Al_{0.25}(OH)₂(CO₃)_{0.125}•0.55(H₂O)•0.13(acetone) |
| Mg(NO₃)₂ | Ga(NO₃)₃ | Na₂CO₃ | Mg₂Ga—CO₃-10 | Mg_{0.75}Ga_{0.25}(OH)₂(CO₃)_{0.125}•0.59(H₂O)•0.12(acetone) |
| Zn(NO₃)₂ | Al(NO₃)₃ | Na₂CO₃ | Zn₂Al—CO₃-8 | Zn_{0.67}Al_{0.33}(OH)₂(CO₃)_{0.125}•0.51(H₂O)•0.07(acetone) |

### 2.1.2 Thermal Treatment of LDH

Synthesized LDHs were thermally treated at 150° C. for 6 h under 1×10⁻² mbar and then kept under nitrogen atmosphere.

### 2.1.3 Synthesis of MAO-Activated AMO-LDH (LDH/MAO Support)

Thermally treated LDH was weighed and slurried in toluene. Methylaluminoxane (MAO) with MAO:LDH weight ratio of 0.4 was prepared in toluene solution and added to the calcined LDH slurry. The resulting slurry was heated at 80° C. for 2 h with occasional swirling. The product was then filtered, washed with toluene, and dried under dynamic vacuum to afford LDH/MAO support.

### 2.1.4 Synthesis of (EBI)ZrCl₂ Supported LDH/MAO Catalyst

LDH/MAO support was weighed and slurried in toluene. The solution of ethylenebis(1-indenyl)zirconium dichloride [(EBI)ZrCl₂] in toluene with LDH/MAO support:catalyst weight ratio of 0.01 was prepared and added to the LDH/MAO slurry. The resulting slurry was heated at 80° C. for 2 h with occasional swirling or until the solution became colourless. The product was then filtered and dried under dynamic vacuum to afford zirconium supported LDH/MAO catalyst.

It is also possible to mix both LDH/MAO and (EBI)ZrCl₂ in the same flask and add the toluene afterwards.

### 2.2 Polymerization of Ethylene

The (EBI)ZrCl₂ supported LDH/MAO catalyst and MAO were weighed with the desired ratio and put together in the Schlenk flask. Hexane was added to the mixture. Ethylene gas was fed to start polymerization at targeted temperature. After the desired time, the reaction was stopped by adding ⁱPrOH/toluene solution. The polymer was quickly filtered and washed with toluene as well as pentane. The polymer was dried in vacuum oven at 55° C. and collected.

### 2.3 Copolymerization of Ethylene and 1-Hexene

The (EBI)ZrCl₂ supported LDH/MAO catalyst and MAO were weighed with the desired ratio and put together in the schlenk flask. Hexane was added to the mixture. Under a flow of ethylene gas, 1-hexene was immediately added to the mixture to start copolymerization at targeted temperature. After the desired time, the reaction was stopped by adding ⁱPrOH/toluene solution. The polymer was quickly filtered and washed with toluene as well as pentane. The polymer was dried in vacuum oven at 55° C. and collected.

### 3. Analytical Data

### 3.1.0 Characterization Methods

X-Ray Diffraction (XRD)—

XRD patterns were recorded on a PANalytical X'Pert Pro instrument in reflection mode with Cu Ka radiation. The accelerating voltage was set at 40 kV with 40 mA current (λ=1.542 A°) at 0.01° s⁻¹ from 1° to 70° with a slit size of ¼ degree.

Fourier Transform Infrared Spectroscopy (FT-IR)—

FT-IR spectra were recorded on a Bio-Rad FTS 6000 FTIR Spectrometer equipped with a DuraSampIIR II diamond accessory in attenuated total reflectance (ATR) mode in the range of 400-4000 cm⁻¹; 100 scans at 4 cm⁻¹ resolution were collected. The strong absorption in the range 2500-1667 cm⁻¹ was from the DuraSampIIR II diamond surface.

Transmission Electron Microscopy (TEM)—

TEM analysis was performed on JEOL 2100 microscope with an accelerating voltage of 400 kV. Samples were dispersed in ethanol with sonication and then cast onto copper TEM grids coated with lacey carbon film.

Scanning Electron Microscopy (SEM) and Energy Dispersive X-Ray Spectrometry (EDS)—

SEM and SEM-EDS analyses were performed on a JEOL JSM 6100 scanning microscope with an accelerating voltage of 20 kV. Powder samples were spread on carbon tape adhered to an SEM stage. Before observation, the samples were sputter coated with a thin Platinum layer to prevent charging and to improve the image quality.

BET Specific Surface Areas—

BET specific surface areas were measured from the N₂ adsorption and desorption isotherms at 77 K collected from a Quantachrome Autosorb-6B surface area and pore size analyzer. Before each measurement, LDH samples were first degassed overnight at 110° C.

Thermal Gravimetric Analysis (TGA)—

The thermal stability of LDHs was studied by TGA (Netzsch) analysis, which was carried out with a heating rate of 10° C. min⁻¹ and an air flow rate of 50 mL min⁻¹ from 25 to 700° C.

The apparent density was determined using the following procedure. The LDH as a free-flowing powder was filled into a 2 ml disposable pipette tip, and the solid was packed as tight as possible by tapping manually for 2 minutes. The weight of the pipette tip was measured before and after the packing to determine the mass of the LDH. Then the apparent density of LDH was calculated using the following equation:

Apparent density=LDH weight (g)/LDH volume (2 ml).

### 3.1.1 X-Ray Powder Diffraction

X-ray powder diffraction pattern for thermally treated LDH revealed lower basal spacing of samples after being calcined at 150° C. for 6 h (Table 3) due to the loss of surface/interlayer solvent and water which was consistent with the TGA results. Divalent anion intercalated LDHs showed greater layer contraction (1.3 Å) than monovalent anion intercalated LDHs (0.5 Å). One possibility was higher density of monovalent anion to stabilize cationic layers causing the difficulty in contraction between layers. Moreover, LDHs could rehydrate and reconstruct after being exposed to ambient atmosphere (FIG. 1), except Zn_{0.67}Al_{0.33}(OH)₂(CO₃)_{0.125}.0.51(H₂O).0.07(acetone) LDH which decomposed after thermal treatment (FIG. 2).

TABLE 3
Summarized d-spacings of synthesised AMO-LDHs

| | d-spacings (\acute{Å}) | | |
|---|---|---|---|
| | Before | After thermal | |
| | thermal | treatment at | |
| LDHs | treatment | 150° C. | Difference |
| Ca_{0.67}Al_{0.33}(OH)₂(NO₃)_{0.125}•0.52(H₂O)•0.16(acetone) | 8.6 | 8.1 | 0.5 |
| Mg_{0.75}Al_{0.25}(OH)₂(NO₃)_{0.25}•0.38(H₂O)•0.12(acetone) | 8.5 | 8.0 | 0.5 |
| Mg_{0.75}Al_{0.25}(OH)₂(Cl)_{0.25}•0.48(H₂O)•0.04(acetone) | 7.8 | 7.8 | 0 |
| Mg_{0.75}Al_{0.25}(OH)₂(SO₄)_{0.125}•0.55(H₂O)•0.13(acetone) | 8.5 | 7.2 | 1.3 |
| Mg_{0.75}Al_{0.25}(OH)₂(CO₃)_{0.125}•0.55(H₂O)•0.13(acetone) | 7.8 | 6.5 | 1.3 |
| Mg_{0.75}Ga_{0.25}(OH)₂(CO₃)_{0.125}•0.59(H₂O)•0.12(acetone) | 7.8 | 6.5 | 1.3 |

### 3.1.2 Thermogravimetric Analysis

The TGA results suggested that all LDHs were thermally stable (crystalline) up to 180° C. Ca_{0.67}Al_{0.33}(OH)₂(NO₃)_{0.125}.0.52(H₂O).0.16(acetone)_LDH showed multiple step weight losses which corresponded to surface acetone, surface/interlayer water elimination, dehydroxylation, and anion removal. Isothermal heating at 150° C., resulted in multiple-step weight loss events starting at approximately at 80° C. which was attributed to the loss of surface/interlayer solvent and water for all LDHs.

### 3.1.3 Infrared Spectroscopy

IR spectroscopic studies of all LDHs indicated two major characteristic peaks: i) broad band with maximum at 3,400-3,680 cm⁻¹ related to —OH stretching of layer double hydroxide as well as interlayer water and ii) strong peak at approximately 1,350 cm⁻¹ related to stretching mode of NO₃⁻ and CO₃²⁻ ion (SO₄²⁻ at 1,100 cm⁻¹) (FIG. 3).

IR spectra of all catalysts exhibited three noticeable characteristic peaks of methylaluminoxane (MAO) at 3,090, 3,020, and 2,950 cm⁻¹ and the diminishing of —OH bending peak of interlayer water at 1,650 cm⁻¹. Also, the results confirmed the remaining of hydroxyl group and anions in the layer structure of catalysts (FIG. 4).

### 3.1.4 Scanning Electron Microscope

SEM image revealed broad size distribution of synthesized LDHs owing to an aggregation excluding Mg_{0.75}Al_{0.25}(OH)₂(SO₄)_{0.125}.0.55(H₂O).0.13(acetone) and Ca_{0.67}Al_{0.33}(OH)₂(NO₃)_{0.125}.0.52(H₂O).0.16(acetone). Mg_{0.75}Ga_{0.25}(OH)₂(CO₃)_{0.125}.0.59(H₂O).0.12(acetone) LDH showed the highest particle size up to ˜400 μm, followed by Mg_{0.75}Al_{0.25}(OH)₂(Cl)_{0.25}.0.48(H₂O).0.04(acetone) (˜200 μm), Mg_{0.75}Al_{0.25}(OH)₂(NO₃)_{0.25}.0.38(H₂O).0.12(acetone) (˜50 μm), Mg_{0.75}Al_{0.25}(OH)₂(CO₃)_{0.125}.0.55(H₂O).0.13(acetone) (˜10 μm), Ca_{0.67}Al_{0.33}(OH)₂(NO₃)_{0.125}.0.52(H₂O).0.16(acetone). (˜5 μm), and Mg_{0.75}Al_{0.25}(OH)₂(SO₄)_{0.125}.0.55(H₂O).0.13(acetone) (˜1 μm), respectively.

However, thermal treatment at 150° C. for 6 h improved particle size dispersity. In addition, the reaction with MAO and (EBI)ZrCl₂ complex did not alter the morphology of thermally treated LDH (FIG. 5).

### 3.2 Polymerization of Ethylene

3.2.1 Conditional Study Using (EBI)ZrCl₂ Supported MAO-Modified Ca_{0.67}Al_{0.33}(OH)₂(NO₃)_{0.125}.0.52(H₂O).0.16(acetone) (LDH/MAO catalyst

Various conditions of ethylene polymerization studied shown in Table 4. The optimal temperature appeared to be 60° C. Increasing temperature from this point did not significantly change the catalytic activity but the molecular weight distribution became bimodal (FIG. 6). The catalyst maintained the average activity regardless of time and catalyst content. Nevertheless, increasing the content of methylaluminoxane (MAO) up to 4000 Al:Zr molar ratio enhanced the polymerization.

TABLE 4
Polymerization of ethylene using (EBI)ZrCl₂ supported MAO-
modified Ca_{0.67}Al_{0.33}(OH)₂(NO₃)_{0.125}•0.52(H₂O)•0.16(acetone)
(LDH/MAO catalyst) under the condition of 1 bar of ethylene, and
25 ml of hexane.

| | | | | | Activity | | | |
|---|---|---|---|---|---|---|---|---|
| | | | | | kg_{PE}/ | kg_{PE}/ | | |
| Catalyst | Co- | [Al]₀/ | T | Time | g_{Zr}/ | mol_{Zr}/ | M_{w}/ | |
| (mg) | catalyst | [M]₀ | (° C.) | (min) | h/bar | h/bar | Mₙ | M_{w} |
| 10 | MAO | 2,000 | 80 | 15 | 4.16 | 1,741 | 3.86 | 210,032 |
| 10 | MAO | 2,000 | 75 | 15 | 5.27 | 2,204 | 3.34 | 202,566 |
| 10 | MAO | 2,000 | 60 | 15 | 5.34 | 2,235 | 3.08 | 195,404 |
| 10 | MAO | 2,000 | 30 | 15 | 1.64 | 686.3 | 4.80 | 390,976 |
| 10 | MAO | 2,000 | 60 | 5 | 4.85 | 2,031 | 3.30 | 220,642 |
| 10 | MAO | 2,000 | 60 | 15 | 5.34 | 2,235 | 3.08 | 195,404 |
| 10 | MAO | 2,000 | 60 | 30 | 4.33 | 1,812 | 3.11 | 194,766 |
| 10 | MAO | 2,000 | 60 | 15 | 5.34 | 2,235 | 3.08 | 195,404 |
| 20 | MAO | 2,000 | 60 | 15 | 5.14 | 2,151 | 3.08 | 195,404 |
| 40 | MAO | 2,000 | 60 | 7 | 5.83 | 2,439 | 3.52 | 334,817 |
| 10 | MAO | 1,000 | 60 | 15 | 5.02 | 2,101 | 3.86 | 302,359 |
| 10 | MAO | 2,000 | 60 | 15 | 5.34 | 2,235 | 3.08 | 195,404 |
| 10 | MAO | 4,000 | 60 | 15 | 8.66 | 3,624 | 3.03 | 221,048 |
| 10 | MAO | 2,000 | 60 | 15 | 5.34 | 2,235 | 3.08 | 195,404 |
| 10 | TIBA | 2,000 | 60 | 15 | 4.99 | 2,089 | 3.44 | 81,650 |
| 10 | TEA | 2,000 | 60 | 15 | 2.65 | 1,110 | 4.43 | 101,754 |

As a cocatalyst, triisobutylaluminium (TIBA) improved the morphology of the polymer but not the catalytic performance compared to MAO (FIG. 7). Unlike TIBA, triethylaluminium (TEA) lessened the catalytic activity by half. The polymeric structure of MAO may be the cause of poor polymer morphology resulting in aggregation. Both TIBA and TEA cocatalysts generated lower molecular weight polyethylene with broader polydispersity index than MAO. MAO is preferred.

Increasing the ethylene pressure doubled the polymer yield with constant rate of polymerization (Table 5).

TABLE 5
Polymerization of ethylene using [(EBI)ZrCl₂] supported MAO modified
Mg_{0.75}Ga_{0.25}(OH)₂(CO₃)_{0.125}•0.59(H₂O)•0.12(acetone) (LDH/MAO) catalyst under
the condition of 10 mg of catalyst, 2000 equiv MAO: 1 (EBI)ZrCl₂, 60°
C., 15 min, hexane (25 ml) with varied ethylene pressure.

| | | | Activity | |
|---|---|---|---|---|
| | Ethylene | Polyethylene | (kg_{PE}/g_{Zr}/h/ | (kg_{PE}/mol_{Zr}/h/ |
| Catalyst | (bar) | yield (g) | bar) | bar) |
| (EBI)ZrCl₂ supported on MAO modified | 1 | 0.216 | 8.65 | 3,621 |
| Mg_{0.75}Ga_{0.25}(OH)₂(CO₃)_{0.125}•0.59(H₂O)•0.12(acetone) | 2 | 0.448 | 8.96 | 3,750 |

### 3.2.2 (EBI)ZrCl₂ Supported LDH/MAO Catalyst Study

To compare between divalent cations in the layer structure of the catalyst support, Ca²⁺ exhibited higher activity than Mg²⁺. On the contrary, no differences was observed for trivalent cations; Al³⁺ and Ga³⁺ (Table 5).

As the component in (EBI)ZrCl₂ supported catalysts, a variety of anions intercalated in MgAl LDHs were studied in ethylene polymerization. Considering the results, divalent anion seemed to be greater active catalyst than monovalent anion. This might (without wishing to be bound) be attributable to crowded monovalent anion between layers leading to less space for monomers to coordinate active sites.

TABLE 6
Polymerization of ethylene using (EBI)ZrCl₂ supported on MAO-modified AMO-LDHs (LDH/MAO) catalysts:
10 mg of catalyst, 1 bar of ethylene, 2000 MAO: 1 equiv (EBI)ZrCl₂, 60° C., 15 min, 25 ml of hexane

| | Activity | | | |
|---|---|---|---|---|
| | kg_{PE}/g_{Zr}/h/ | kg_{PE}/mol_{Zr}/h/ | Polymer | Polymer |
| Catalyst | bar | bar | M_{w}/Mₙ | Mw |
| [(EBI)ZrCl₂] supported on MAO-modified | 5.34 | 2,235 | 3.08 | 195,404 |
| Ca_{0.67}Al_{0.33}(OH)₂(NO₃)_{0.125}•0.52(H₂O)•0.16(acetone) | | | | |
| [(EBI)ZrCl₂] supported on MAO-modified | 2.49 | 1,040 | 3.29 | 221,647 |
| Mg_{0.75}Al_{0.25}(OH)₂(NO₃)_{0.25}•0.38(H₂O)•0.12(acetone) | | | | |
| [(EBI)ZrCl₂] supported on MAO-modified | 6.75 | 2,826 | 3.08 | 244,467 |
| Mg_{0.75}Al_{0.25}(OH)₂(Cl)_{0.25}•0.48(H₂O)•0.04(acetone) | | | | |
| [(EBI)ZrCl₂] supported on MAO-modified | 14.9 | 6,215 | 3.14 | 270,964 |
| Mg_{0.75}Al_{0.25}(OH)₂(SO₄)_{0.125}•0.55(H₂O)•0.13(acetone) | | | | |
| [(EBI)ZrCl₂] supported on MAO-modified | 9.06 | 3,790 | 3.47 | 286,980 |
| Mg_{0.75}Al_{0.25}(OH)₂(CO₃)_{0.125}•1.36(H₂O)•0.17(acetone) | | | | |
| [(EBI)ZrCl₂] supported on MAO-modified | 2.37 | 990.1 | 3.47 | 240,361 |
| Mg_{0.75}Al_{0.25}(OH)₂(B₄O₅(OH)₄)_{0.125}•0.53(H₂O)•0.21 (acetone) | | | | |
| [(EBI)ZrCl₂] supported on MAO-modified | 8.65 | 3,621 | 3.39 | 275,826 |
| Mg_{0.75}Ga_{0.25}(OH)₂(CO₃)_{0.125}•0.59(H₂O)•0.12(acetone) | | | | |

(EBI)ZrCl₂ supported LDH/MAO catalysts displayed polydispersity index in the range of 3.08 to 3.47. Among the catalysts, Mg_{0.75}Al_{0.25}(OH)₂(CO₃)_{0.125}.1.76H₂O.0.45(Acetone), Mg_{0.75}Ga_{0.25}(OH)₂(CO₃)_{0.125}.0.59(H₂O).0.12(acetone) and Mg_{0.75}Al_{0.25}(OH)₂(SO₄)_{0.125}.0.55(H₂O).0.13(acetone) LDH/MAO supported catalyst expressed high in both catalytic performance and molecular weight of the polymer (270,964 286,980), whereas polyethylene obtained from Ca_{0.67}Al_{0.33}(OH)₂(NO₃)_{0.125}.0.52(H₂O).0.16(acetone) LDH/MAO catalyst showed the lowest molecular weight (195,404).

Polyethylene obtained from most of the catalysts started to degrade thermally at approximately 300° C. (FIG. 8).

### 3.3 Copolymerization of Ethylene and 1-Hexene

An addition of comonomer, 1-hexene, improved the rate of polymerization (Table 7). At increasing 1-hexene content, copolymer became more translucent with lower molecular weight. Polydispersity index was lowest at 1-hexene concentration of 0.10 M. However, the monomer content did not significantly affect the thermal properties of the polymer (FIG. 9).

TABLE 7
Copolymerization of ethylene and 1-hexene
using (EBI)ZrCl₂ supported on MAO modified
Mg_{0.75}Al_{0.25}(OH)₂(SO₄)_{0.125}•0.55(H₂O)•0.13
(acetone) (LDH/MAO) catalyst: 10 mg of catalyst,
1 bar of ethylene, 2000 Al(MAO): 1 equiv (EBI)ZrCl₂,
60° C., 15 min, 25 ml of hexane

| | | | Activity | | | |
|---|---|---|---|---|---|---|
| | 1-Hexene | | (kg_{PE}/ | (kg_{PE}/ | | |
| | content | | g_{Zr}/ | mol_{zr}/ | M_{w}/ | |
| Catalyst | (M) | (g) | h/bar) | h/bar) | Mₙ | M_{w} |
| [(EBI)ZrCl₂] supported on | 0 | 0 | 14.9 | 6,215 | 3.14 | 270,964 |
| MAO-modified | 0.05 | 0.11 | 21.7 | 9,074 | 3.45 | 205,992 |
| Mg_{0.75}Al_{0.25}(OH)₂(SO₄)_{0.125}• | 0.10 | 0.21 | 29.2 | 12,211 | 2.09 | 91,944 |
| 0.55(H₂O)•0.13(acetone) | 0.20 | 0.42 | 38.4 | 16,081 | 2.20 | 87,075 |
| (LDH/MAO) | | | | | | |

### 3.4 Other Transition Metal Compounds

The catalyst support prepared according to the present invention may be equally utilized to support other transition metal compounds known for the polymerization of ethylene and other alpha-olefins. Within the art, transition metal compound catalysts belonging to the families of metal mono indenyl and di(indenyl), metal mono and di(cyclopentadienyl), metal ansa-bridged cyclopentadienyl and indenyl, metal(constrained geometry), metal(phosphine-imido), metal(permethylpentalene), metal(diimine) catalysts and the so called metal bis(phenoxy-imine) (now known as FI) catalysts were tested. Selected examples are collated Table 8.

TABLE 8
Polymerisation of ethylene using different metal complex supported
on MAO-modified Mg_{0.75}Al_{0.25}(OH)₂(CO₃)_{0.125}•1.76H₂O•0.45(Acetone)
(AMO-LDH/MAO catalysts)

| | | Polyethylene | | |
|---|---|---|---|---|
| | T | Productivity | | |
| Metal complex | (° C.) | kg_{PE}/g_{CAT}/h | M_{w}/Mₙ | M_{w} |
| [(EBI)ZrCl₂] | 60 | 0.121 | 4.08 | 194,134 |
| [^{(2-Me,4-Ph}SBI)ZrCl₂] | 60 | 0.200 | 3.93 | 437,490 |
| [(Cp^{nBu})₂ZrCl₂] | 60 | 0.211 | 3.40 | 744,533 |
| [(Cp^{tBu})₂HfCl₂] | 60 | 0.004 | 4.77 | 679,829 |
| [(^{2,6-Me—Ph}DI)NiBr₂] | 60 | 0.003 | 5.57 | 694,096 |
| [(Cp^{Me4})Me₂SiN(^{t}Bu)TiCl₂] | 60 | 0.025 | 4.26 | 1,032,406 |
| [(Cp*)TiCl₂Me₂(N{P^{t}Bu}₃] | 60 | 0.305 | 2.51 | 269,665 |
| [(^{Mes}PDI)FeCl₂] | 60 | 0.511 | 13.51 | 368,083 |
| [(^{2,6-MePh}NDI)PdClMe] | 60 | 0.002 | | |
| [(^{ArF5}FI)ZrCl₂] | 60 | 0.128 | 7.03 | 448,022 |

EBI = C₂H₄(indenyl)₂; ^{2-Me-4-Ph}SBI = (Me)₂Si{(2-Me,4-Ph-indenyl)}; Cp^{nBu} = C₅H₄(nBu); ^{2,6-Me—Ph}DI = 2,6-(PhMe)₂C₆H₃—N═C(Me)—C(Me)═N-2,6-(PhMe)₂C₆H₃; Cp^{Me4} = C₅Me₄H; Cp* = C₅Me₅; ^{Mes}PDI = 2,6-(1,3,5-Me—C₆H₃N═CMe)₂C₅H₃N)}.
Mg_{0.75}Al_{0.25}(OH)₂(CO₃)_{0.125}•1.76H₂O•0.45(Acetone), 10 mg of catalyst, 2 bar, 1 hour, [TIBA]₀/[M]₀ = 1000, Hexane (50 ml).

The chemical structures of the metal complexes used are given below:

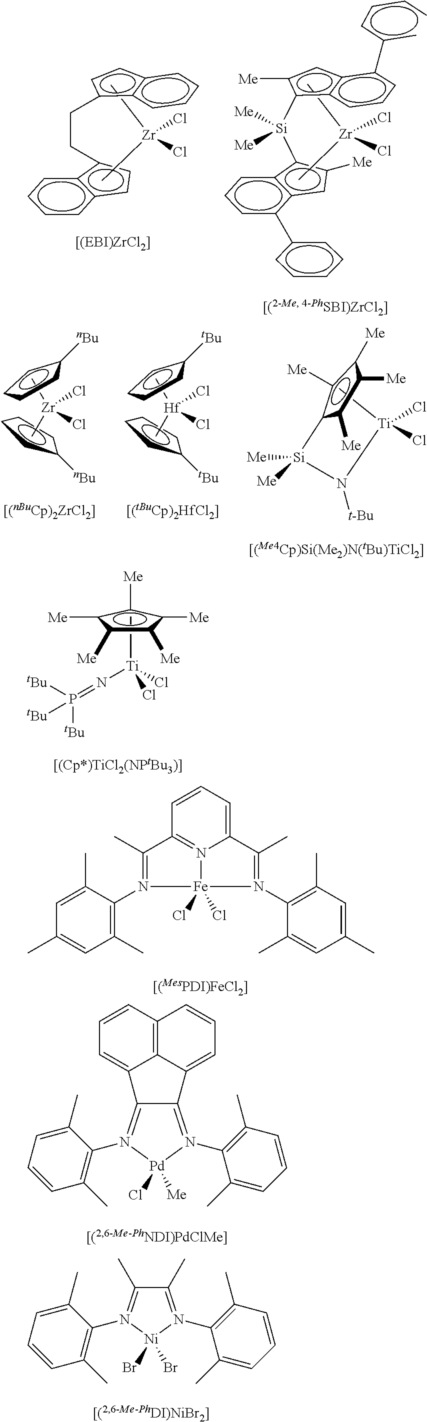

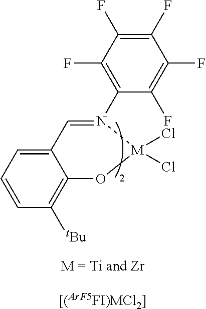

### 3.5 Variation of the LDHs

TABLE 9
Polymerisation of ethylene using AMO-LDH/MAO/[complex]
catalyst under the condition: 10 mg of catalyst, 2 bar, 1 hour, 60°
C., [TIBA]₀/[M]₀ = 1000, Hexane (50 ml).

| | | Polyethylene |
|---|---|---|
| | | Productivity |
| AMO-LDH | Complex | kg_{PE}/g_{CAT}/h |
| Mg_{0.75}Al_{0.25}(OH)₂(CO₃)_{0.125}•1.76(H₂O)•0.45(Acetone) | [(^{Mes}PDI)FeCl₂] | 0.511 |
| Mg_{0.75}Al_{0.25}(OH)₂(SO₄)_{0.125}•0.55(H₂O)•0.13(acetone) | [(^{Mes}PDI)FeCl₂] | 0.562 |
| Mg_{0.75}Al_{0.25}(OH)₂(Cl)_{0.25}•0.48(H₂O)•0.04(acetone) | [(^{Mes}PDI)FeCl₂] | 0.260 |
| Mg_{0.75}Al_{0.25}(OH)₂(CO₃)_{0.125}•1.76(H₂O)•0.45(Acetone) | [(EBI*)ZrCl₂] | 0.081 |
| Mg_{0.75}Al_{0.25}(OH)₂(SO₄)_{0.125}•0.55(H₂O)•0.13(acetone) | [(EBI*)ZrCl₂] | 0.147 |
| Mg_{0.75}Al_{0.25}(OH)₂(Cl)_{0.25}•0.48(H₂O)•0.04(acetone) | [(EBI*)ZrCl₂] | 0.093 |

(EBI*)ZrCl₂ = ethylenebis(1-permethylindenyl)zirconium dichloride
(^{Mes}PDI)FeCl₂ = {2,6-(1,3,5-Me—C₆H₃N═CMe)₂C₅H₃N)}FeCl₂

As expected, when using the iron complexes, all the results are higher than when the zirconium complex was used. Surprisingly, (EBI*)ZrCl₂ supported on MAO modified Mg_{0.75}Al_{0.25}(OH)₂(Cl)_{0.25}.0.48(H₂O).0.04(acetone) was much more active than (EBI*)ZrCl₂ supported on MAO modified Mg_{0.75}Al_{0.25}(OH)₂(CO₃)_{0.125}.1.76H₂O.0.45(Acetone) LDH (0.093 and 0.081 kg_{PE}/g_{CAT}/h respectively), Table 9.

### 3.6 Comparison of the AMO-LDHs Versus Conventional and Commercial LDHs.

The catalytic properties of different MAO-modified LDHs were studied; the aqueous miscible organic (AMO-LDHs), conventional (synthesised by know co-precipitation methods) and a commercial grade LDH (PURAL MG 62, SASOL, previously Condea) were used. The results are collated in Table 10

TABLE 10
Polymerisation of ethylene using metal complexes supported on different
types of LDH/MAO support under the conditions: 10 mg of catalyst, 2 bar, 1 hour,
60° C., [TIBA]₀/[complex]₀ = 1000, Hexane (50 ml).

| | | Polyethylene |
|---|---|---|
| | | Productivity |
| LDH/MAO | Complex | kg_{PE}/g_{CAT}/h |
| Mg_{0.75}Al_{0.25}(OH)₂(CO₃)_{0.125}•1.76H₂O•0.45(Acetone) | [[EBI)ZrCl₂] | 0.122 |
| Mg_{0.75}Al_{0.25}(OH)₂(CO₃)_{0.125}•1.67H₂O | [[EBI)ZrCl₂] | 0.095 |
| PURAL MG 62 | [[EBI)ZrCl₂] | No Catalyst |
| Mg_{0.75}Al_{0.25}(OH)₂(CO₃)_{0.125}•1.76H₂O•0.45(Acetone) | [(^{Mes}PDI)FeCl₂] | 0.511 |
| PURAL MG 62 | [(^{Mes}PDI)FeCl₂] | 0.050 |
| Mg_{0.75}Al_{0.25}(OH)₂(Cl)_{0.25}•0.48(H₂O)•0.04(acetone) | [(^{Mes}PDI)FeCl₂] | 0.260 |
| Mg_{0.75}Al_{0.25}(OH)₂(Cl)_{0.25}•0.61(H₂O) | [(^{Mes}PDI)FeCl₂] | 0.026 |

PURAL MG 62 is a commercial grade LDH supplied by SASOL, (previously Condea)

### 3.7 Variation of the Thermal Treatment on AMO-LDH

TABLE 11
Variation in polymerisation of ethylene using complex-supported MAO-modified
Mg_{0.75}Al_{0.25}(OH)₂(CO₃)_{0.125}•1.76H₂O•0.45(Acetone). Before MAO-modification
the LDH was thermally treated at a range of different temperatures.

| Thermal Treatment Temperature for | | Polyethylene |
|---|---|---|
| Mg_{0.75}Al_{0.25}(OH)₂(CO₃)_{0.125}•1.76H₂O•0.45(Acetone) | | Productivity |
| before MAO modification/(° C.) | Complex | kg_{PE}/g_{CAT}/h |
| 25 | [[EBI)ZrCl₂] | 0.001 |
| 50 | [[EBI)ZrCl₂] | 0.002 |
| 100 | [[EBI)ZrCl₂] | 0.049 |
| 125 | [[EBI)ZrCl₂] | 0.121 |
| 150 | [[EBI)ZrCl₂] | 0.122 |
| 190 | [[EBI)ZrCl₂] | 0.038 |
| 25 | [(^{Mes}PDI)FeCl₂] | 0.006 |
| 50 | [(^{Mes}PDI)FeCl₂] | 0.006 |
| 100 | [(^{Mes}PDI)FeCl₂] | 0.208 |
| 125 | [(^{Mes}PDI)FeCl₂] | 0.374 |
| 150 | [(^{Mes}PDI)FeCl₂] | 0.511 |
| 190 | [(^{Mes}PDI)FeCl₂] | 0.386 |

Catalysis conditions: 10 mg of catalyst, 2 bar, 1 hour, 60° C., [TIBS]₀/[complex]₀ = 1000, Hexane (50 ml).

Table 11 shows when using (EBI)ZrCl₂ supported MAO-modified Mg_{0.75}Al_{0.25}(OH)₂(CO₃)_{0.125}.1.76H₂O.0.45(Acetone) [AMO-LDH/MAO/[(EBI)ZrCl₂], thermal treatment in range of 125-150° C. provided the highest productivities, most preferably 150° C. Using (^{Mes}PDI)FeCl₂ supported on MAO-modified Mg_{0.75}Al_{0.25}(OH)₂(CO₃)_{0.125}.1.76H₂O.0.45(Acetone) also showed that 150° C. was the best thermal treatment temperature.

The features disclosed in the foregoing description, in the claims and in the accompanying drawings may both separately or in any combination be material for realizing the invention in diverse forms thereof.

1. A process for preparing a catalyst support comprising a layered double hydroxide (LDH), the process comprising,
a) providing a water-wet layered double hydroxide of formula:
[M^{z+}₁₋ₓM′^{y+}ₓ(OH)₂]^{a+}(Xⁿ⁻)_{a/r}.bH₂O (1)
wherein M and M′ are metal cations, z=1 or 2; y=3 of 4, x is 0.1 to 1, b is 0 to 10, X is an anion, r is 1 to 3, n is the charge on the anion and a is a=z(1−x)+xy−2,
b) maintaining the layered double hydroxide water-wet,
c) contacting the water-wet layered double hydroxide with at least one solvent, the solvent being miscible with water, and
d) thermally treating the material obtained in step c) to produce a catalyst support.

2. The process as claimed in claim 1, wherein M is Mg, Zn, Fe, Ca or a mixture of two or more thereof.

3. The process as claimed in claim 1 wherein M′ is Al, Ga, Fe or a mixture of Al and Fe.

4. The process as claimed in claim 1 wherein z is 2 and M is Ca, Mg, or Zn.

5. The process as claimed in claim 1 wherein M′ is Al.

6. The process as claimed in claim 1 wherein M is Zn, Mg or Al, and M′ is Al.

7. The process as claimed in claim 1 wherein X is selected from halide, inorganic oxyanions, organic anions, surfactants, anionic surfactants, anionic chromophores, and/or anionic UV absorbers.

8. The process as claimed in claim 1 wherein the at least one solvent is an organic solvent selected from acetone, acetonitrile, dimethylformamide, dimethyl sulfoxide, dioxane, ethanol, methanol, n-propanol, 2-propanol, tetrahydrofuran or a mixture of two or more thereof.

9. The process as claimed in claim 1 wherein the thermal treatment comprises heating at a temperature in the range 110° C. to 1000° C., for a predetermined time at a predetermined pressure, optionally under a flow of an inert gas or under reduced pressure.

10. The process as claimed in claim 9, wherein the predetermined pressure is in the range of 1×10⁻¹ to 1×10⁻³ mbar.

11. A process for producing a solid catalyst, the process comprising providing a catalyst support prepared by the process of claim 1, and contacting the support with an activator.

12. The process as claimed in claim 11, further comprising contacting the support with at least one metal-organic transition metal compound before, simultaneously with, or after contacting the support with the activator.

13. A polymerisation catalyst comprising,
a) a catalyst support prepared according to the process of claim 1, and
b) at least one metal-organic compound.

14. The catalyst as claimed in claim 13, further comprising an activator.

15. The catalyst as claimed in claim 14, wherein the activator comprises an alkyl aluminum activator.

16. The catalyst as claimed in claim 13, wherein the metal-organic compound comprises a transition metal compound.

17. The catalyst as claimed in claim 13, wherein the catalyst is an olefin polymerisation catalyst.

18. The catalyst as claimed in claim 13, further comprising one or more metal compounds of the formula (II)
M³(R¹)_{w}(R²)ₛ(R³)ₜ II
wherein
M³ is an alkali metal, an alkaline earth metal or a metal of group 13 of the Periodic Table,
R¹ is hydrogen, C₁-C₁₀-alkyl, C₆-C₁₅-aryl, alkylaryl or arylalkyl each having from 1 of 10 carbon atoms in the alkyl part and from 6 to 20 carbon atoms in the aryl part,
R² and R³ are each independently selected from hydrogen, halogen, pseudohalogen, C₁-C₁₀-alkyl, C₆-C₁₅-aryl, alkylaryl, arylalkyl or alkoxy each having from 1 to 10 carbon atoms in the alkyl radical and from 6 to 20 carbon atoms in the aryl radical,
w is an integer from 1 to 3, and
s and t are integers from 0 to 2, with the sum w+s+t corresponding to the valence of M³.

19. (canceled)

20. The catalyst as claimed in claim 16 wherein the transition metal compound is selected from a titanium, zirconium, hafnium, iron, nickel and/or cobalt compound.
